(19) United States
(12) Patent Application Publication
(10) Pub. No.: US 2026/0318227 A1
(43) Pub. Date: Oct. 15, 2026

(54) METHOD FOR MANUFACTURING AN INTERMEDIATE CASING FOR AN AIRCRAFT TURBINE ENGINE AND ASSOCIATED MANUFACTURING METHOD

(71) Applicant: SAFRAN, Paris (FR)

(72) Inventors: Remi Roland Robert MERCIER, Moissy-Cramayel (FR); Naoufel BEN SALEM, Moissy-Cramayel (FR)

(21) Appl. No.: 19/484,293

(22) PCT Filed: May 17, 2024
(86) PCT No.: PCT/FR2024/050643

§ 371 Date: Nov. 13, 2025

(30) Foreign Application Priority Data
May 26, 2023 (FR) FR2305250

(51) Int. Cl. F01D 25/24

(52) U.S. Cl. CPC F01D 25/24; F05D 2220/323; F05D 2230/10

(57) ABSTRACT

An annular intermediate casing for an aircraft turbine engine, the intermediate casing having an axis of revolution and including an annular inner shroud centered on the axis of revolution; an annular outer shroud arranged coaxially around the inner shroud; and radial arms connecting the inner and outer shrouds, the intermediate casing wherein the outer shroud includes an annular inner panel centered on the axis of revolution and extending around the arms; an annular outer panel arranged coaxially around the inner panel; and an annular core arranged coaxially between the inner and outer panels.

### TECHNICAL FIELD OF THE INVENTION

The invention relates to the field of intermediate casings for the aircraft turbine engines.

The invention also relates to the manufacture of these intermediate casings.

### TECHNICAL BACKGROUND

An aircraft turbine engine typically has a longitudinal axis. It comprises, for example, from upstream to downstream in the direction of gas flow along the longitudinal axis, a fan, a low-pressure compressor, a high-pressure compressor, a combustion chamber, a high-pressure turbine, a low-pressure turbine and a gas exhaust nozzle.

The fan allows the suction of an air flow divided into a primary flow and a secondary flow. The primary flow passes through a primary duct of the turbine engine while the secondary flow is directed towards a secondary duct surrounding the primary duct.

The primary flow is compressed in the compressors. The compressed air is then mixed with a fuel and burned within the combustion chamber. The gases resulting from the combustion pass through the turbines then escape through the nozzle whose cross-section allows the acceleration of these gases to generate the propulsion.

The fan typically comprises a disc movable in rotation about the longitudinal axis and blades mounted on the disc. The blades are surrounded by a fan casing centered on the longitudinal axis and configured to retain the blades in the event of damage, for example to the blades.

The fan casing is typically surrounded by a nacelle that allow to protect the fan. A fan of this type is said to be ducted, as opposed to non-ducted fans whose blades are not surrounded by a casing.

The turbine engine also comprises an intermediate casing located downstream of the fan casing. The intermediate casing typically comprises an annular inner shroud centered on the longitudinal axis and an annular outer shroud arranged coaxially around the inner shroud. Together with the inner shroud, the outer shroud defines a portion of the secondary duct v2. The intermediate casing also comprises radial arms connecting the inner and outer shrouds. The radial arms are typically connected to the outer shroud by platforms arranged radially between the arms and a downstream annular part of the outer shroud. The outer shroud also comprises an upstream annular part connected axially to the fan casing.

The turbine engines is a major source of noise pollution and there is a strong demand to reduce this type of pollution. To this end, it was proposed that the outer shroud of the intermediate casing should be equipped with acoustic panels to reduce the noise generated by the turbine engines.

An acoustic panel typically comprises a sandwich structure comprising inner and outer panels, and between which is arranged a core having, for example, a honeycomb structure configured to absorb the sound waves. The inner panel also has holes to allow sound waves to propagate into the core through which they are absorbed.

Such an acoustic panel is typically manufactured in the form of angular sectors, each of which is fitted and attached to the upstream part of the outer shroud. The acoustic panels are secured to the outer shroud of the intermediate casing by rivet-type attachment elements.

Although it significantly reduces the noise pollution generated by the turbine engine, this type of acoustic panel is not entirely satisfactory. The attachment means tend to reduce the acoustic performance because they are permeable to the acoustic waves. These attachment means also considerably increase the weight of the intermediate casing. The presence of the platforms also prevents the acoustic panels from being arranged in the downstream annular part of the outer shroud, further reducing the acoustic performance of the outer shroud. Finally, the manufacture of such acoustic panels and their installation in the intermediate casing are long and tedious operations, and consequently costly.

There is therefore a need to provide an intermediate casing for an aircraft turbine engine that has good acoustic insulation performance while being light, easy to manufacture and inexpensive.

### SUMMARY OF THE INVENTION

To this end, the invention proposes an annular intermediate casing for an aircraft turbine engine, the intermediate casing having an axis of revolution and comprising:
an annular inner shroud centered on the axis of revolution,
an annular outer shroud arranged coaxially around the inner shroud, and
radial arms connecting the inner and outer shrouds,
   the intermediate casing being remarkable in that the outer shroud comprises:
an annular inner panel centered on the axis of revolution and extending around the arms,
an annular outer panel arranged coaxially around the inner panel, and
an annular core arranged coaxially between the inner and outer panels.

According to the invention, the outer shroud of the intermediate casing comprises inner and outer panels between which the core is arranged. In this way, the outer shroud of the intermediate casing directly incorporates the acoustic insulation properties.

Thanks to the invention, it is possible to dispense with sectors of acoustic panels and the elements for attaching these panels, and therefore to simplify the method for manufacturing and assembling these panels. The intermediate casing is therefore lighter and less expensive.

Thanks to the invention, the acoustic properties of the intermediate casing are also considerably improved.

The invention may comprise one or more of the following characteristics, taken alone or in combination with each other:
the outer shroud comprises an upstream annular part and a downstream annular part located around the arms, the core being located at least in the upstream annular part;
the core is located in both the upstream and downstream annular parts;
the inner panel comprises a first polymeric matrix and reinforcing fibers embedded in the first matrix;
the outer panel comprises a second polymeric matrix and reinforcing fibers embedded in the second matrix;
the polymers of the first and/or second matrices are chosen from thermoplastics or thermosets;
there are holes in the inner panel.

The invention also relates to a method for manufacturing an annular intermediate casing according to any one of the preceding characteristics, the method being remarkable in that it comprises a step (c) of producing the outer shroud, the step (c) comprising the following chronological sub-steps:
(c1) forming an annular inner panel centered on an axis of revolution,
(c2) placing an annular core coaxially around the inner panel,
(c3) forming an outer panel coaxially around the core, and
(c4) optionally, treating thermally the inner and outer panels.

The method may comprise one or more of the following characteristics, taken alone or in combination with each other:
sub-steps (c1) and/or (c3) are carried out by an automatic fiber placement method,
after sub-step (c4), a step (c5) of drilling the inner panel,
the drilling step (c5) is carried out by mechanical or laser drilling,
sub-steps (c1) and (c3) comprise the following steps:
winding strips of pre-impregnated fibers along the axis of revolution,
compacting and heating the strips to a first temperature below the thermal treatment temperature of step (c4),
the first temperature is between 20 °C and 500 °C,
sub-step (c3) is carried out by additive manufacturing,
sub-step (c4) is carried out in an autoclave,
the core has a honeycomb structure.

### BRIEF DESCRIPTION OF THE FIGURES

Further characteristics and advantages will be apparent from the following description of non-limiting embodiments of the invention with reference to the accompanying drawings wherein:

FIG. 1 is a schematic representation in longitudinal cross-section of an aircraft half-turbine engine,

FIG. 2 is a schematic perspective view of an intermediate casing according to the invention,

FIG. 3 is a schematic representation of the outer shroud equipped to the intermediate casing according to the invention,

FIG. 4 is a schematic longitudinal sectional view of the intermediate casing according to one embodiment of the invention,

FIG. 5 is a schematic longitudinal sectional view of the intermediate casing according to another embodiment of the invention,

FIG. 6 is a block diagram of a manufacturing method according to the invention,

FIG. 7 is a schematic representation of an installation for manufacturing the outer shroud,

FIG. 8 is a schematic representation of a manufacturing station for the inner and outer panels of the outer shroud.

### DETAILED DESCRIPTION OF THE INVENTION

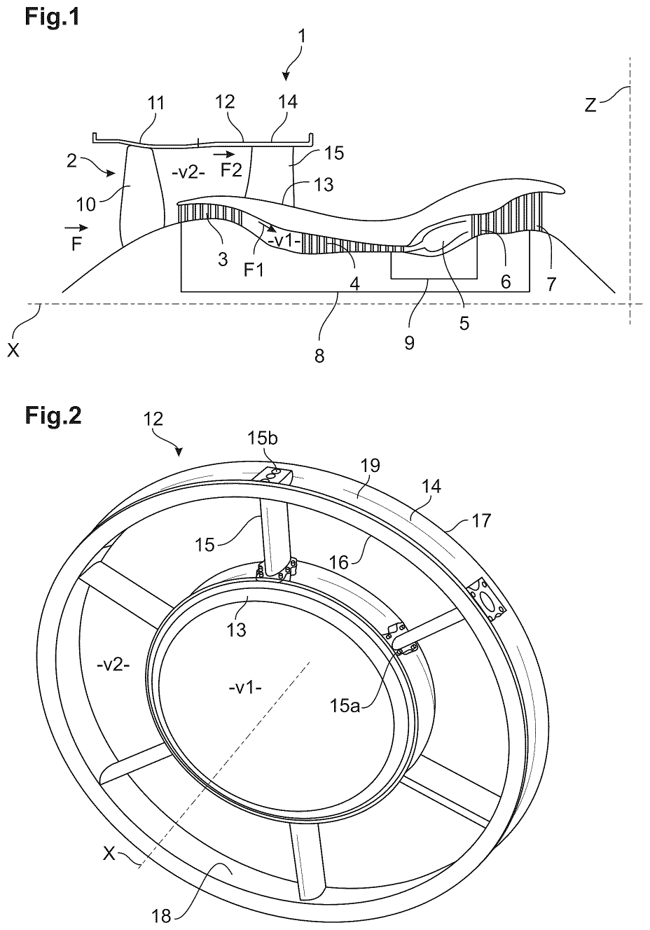

An example of a turbine engine 1 for an aircraft is shown in FIG. 1. The turbine engine 1 extends around and along a longitudinal axis X.

In this application, the terms “upstream” and “downstream” are defined in relation to the direction of gas flow in the turbine engine 1 along the longitudinal axis X.

The terms “axial”, “axially”, “radial” and “radially” are defined in relation to the longitudinal axis X.

The terms “internal”, “inner”, “internally”, “external”, “outer”, “externally”, are defined in relation to the distance from the longitudinal axis X along an axis Z perpendicular to the longitudinal axis X.

The turbine engine 1 is preferably a turbojet engine, for example a turbojet engine with a double body and dual flow. It comprises, from upstream to downstream, a fan 2, at least one compressor such as a low-pressure compressor 3 and a high-pressure compressor 4, a combustion chamber 5, at least one turbine such as a high-pressure turbine 6 and a low-pressure turbine 7, and a gas exhaust nozzle.

The low- and high-pressure compressors 3, 4 and the high-and low-pressure turbines 6, 7 each comprise at least one rotor. The rotor of the low-pressure compressor 3 is connected to the rotor of the low-pressure turbine 7 by a low-pressure shaft 8 and the rotor of the high-pressure compressor 4 is connected to the rotor of the high-pressure turbine 6 by a high-pressure shaft 9. The high-pressure shaft 9 is arranged coaxially around the low-pressure shaft 8. The low and high pressure shafts 8, 9 are centered on the longitudinal axis X.

The fan 2 comprises a disc rotatable about the longitudinal axis X and blades 10 extending radially from the disc. The fan 2 also comprises a fan shaft (not shown) connected to the low-pressure shaft 8 by means of a speed reducer, for example.

The fan 2 allows the suction of an air flow F divided into a primary air flow F1 and a secondary air flow F2. The primary air flow F1 passes through a primary duct v1 of the turbine engine 1 and the secondary flow F2 flows into a secondary duct v2 of the turbine engine 1. The secondary duct v2 surrounds the primary duct v1.

The primary flow F1 is compressed in the low-pressure compressor 3 and then in the high-pressure compressor 4. The compressed air is then mixed with a fuel and burned within the combustion chamber 5. The gases formed by the combustion pass through the high-pressure and low-pressure turbines 6, 7. The gases escape finally through the nozzle whose cross-section allows the acceleration of these gases to generate the propulsion.

The fan 2 is of the ducted type. The turbine engine 1 also comprises a fan casing 11. The fan casing 11 is annular and centered on the longitudinal axis X. It is arranged around the blades 10. The fan casing 11 forms a portion of the secondary duct v2.

The turbine engine 1 also comprises an intermediate casing 12. The intermediate casing 12 is located downstream of the fan casing 11.

With reference to FIG. 2, the intermediate casing 12 has an axis of revolution which coincides with the longitudinal axis X of the turbine engine 1 when the intermediate casing 12 is mounted in the turbine engine 1. The intermediate casing 12 comprises an inner shroud 13 and an outer shroud 14 connected by arms 15.

The inner shroud 13 is annular and centered on the longitudinal axis X. The inner shroud 13 is made of metal, for example. It externally delimits a portion of the primary duct v1.

The outer shroud 14 is annular and centered on the longitudinal axis X. It is arranged coaxially around the inner shroud 13. The outer shroud 14, together with the inner shroud 13, forms a portion of the secondary duct v2.

The outer shroud 14 has a thickness e as measured along the radial axis Z of between 10 mm and 50 mm.

The outer shroud 14 comprises an upstream annular part 16 and a downstream annular part 17. Preferably, the downstream annular part 17 is located around the arms 15. The upstream annular part 16 is connected axially to the fan casing 11.

In order to reduce the noise pollution generated by the turbine engine 1, the outer shroud 14 incorporates acoustic insulation properties. Advantageously, the outer shroud 14 is able to absorb an acoustic energy over a frequency range of between 100 Hz and 1500 Hz.

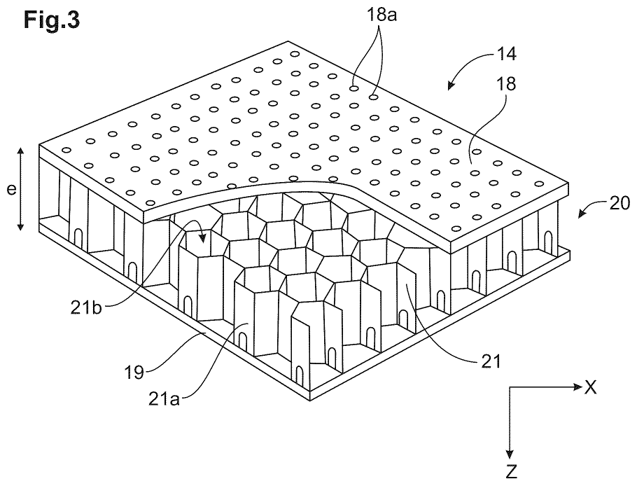

The outer shroud 14 has a sandwich structure. According to the invention, and with reference to FIG. 3, the outer shroud 14 comprises an annular inner panel 18, an annular outer panel 19 and an annular core 20, advantageously with a honeycomb structure 21. Advantageously, the outer shroud 14 forms a monolithic part.

The inner panel 18 is centered on the longitudinal axis X. It extends around the arms 15. The inner panel 18 is the innermost layer of the outer shroud 14. The inner panel 18 comprises a first composite material comprising a first polymeric matrix and reinforcing fibers embedded in the first matrix.

The polymeric material of the first matrix is chosen, for example, from thermoplastics such as polyolefins, for example polyethylene or polypropylene, or thermosets such as epoxides or thermosets such as epoxides or polybismaleimides.

The reinforcing fibers are chosen, for example, from carbon, glass or polyamide fibers.

The carbon fibers are, for example, polyaryletherketone (PAEK) fibers such as polyetherketone (PEK), polyetheretherketone (PEEK) or polyetherketoneketone (or PEKK), or polyacrylonitrile (PAN) fibers such as HexTow® AS4, AS7 or IM7 fibers marketed by Hexcel.

Advantageously, the fibers are continuous fibers, i.e. rovings made up of assemblies of parallel or twisted continuous filaments.

Advantageously, the fibers are high-strength and/or intermediate-modulus fibers, for example with a modulus of between 200 GPa and 250 GPa, or high-modulus fibers, for example with a modulus of up to 350 GPa.

The inner panel 18 has holes 18a. The holes 18a are through holes. In this way, they pass through the entire thickness of the inner panel 18. The holes 18a, for example, have a circular cross-section. They have a diameter of, for example, between 5 mm and 0.1 mm, less than 1 mm, and advantageously between 0.1 mm and 0.8 mm. The diameter of the holes 18a reduces the aerodynamic drag of the turbine engine 1. The inner panel 18 is in contact with the secondary flow F2 and its presence disturbs the flow of the secondary flow F2. Such a disturbance generates an aerodynamic drag which reduces the performance of the turbine engine 1. The holes 18a are made by laser drilling or mechanical drilling.

For example, the inner panel 18 has a thickness of between 0.5 mm and 2 mm, preferably between 0.8 mm and 2 mm.

The inner panel 18 is advantageously produced by automatic fiber placement.

The outer panel 19 is arranged coaxially around the inner panel 18. The outer panel 19 is the outermost layer of the outer shroud 14.

The outer panel 19 comprises a second composite material. The second composite material comprises a second polymer matrix and reinforcing fibers embedded in the second matrix.

The polymeric material of the second matrix is chosen from thermoplastics or thermosets. The thermoplastic or thermosetting material may be the same as or different from the thermoplastic or thermosetting material of the first polymer matrix. The thermoplastic of the second matrix is for example chosen from polyolefins such as polyethylene, polypropylene or fluorinated polymers or polyamides or polyaryletherketones such as polyetheretherketone (PEEK). According to another example, the thermoset of the second matrix is chosen from epoxies or polybismaleimides.

The reinforcing fibers are chosen from carbon, glass and polyamide fibers, for example.

The carbon fibers are, for example, polyaryletherketone (PAEK) fibers such as polyetherketone (PEK), polyetheretherketone (PEEK) or polyetherketoneketone (or PEKK), or polyacrylonitrile (PAN) fibers such as HexTow® AS4, AS7 or IM7 fibers marketed by Hexcel.

Advantageously, the fibers are continuous fibers, i.e. rovings made up of assemblies of parallel or twisted continuous filaments.

Advantageously, the fibers are high-strength and/or intermediate-modulus fibers, for example with a modulus of between 200 GPa and 250 GPa, or high-modulus fibers, for example with a modulus of up to 350 GPa.

The reinforcing fibers may be identical to or different from the reinforcing fibers of the inner panel 18.

The outer panel 19 is advantageously produced by the automatic fiber placement method.

Advantageously, the outer panel 19 has a thickness of between 1 mm and 20 mm, even more advantageously between 1 mm and 15 mm. Advantageously, the inner and outer panels 18, 19 have the same thickness.

The core 20 is annular and centered on the longitudinal axis X. It is arranged coaxially between the inner panel 18 and the outer panel 19. The core 12 may have a honeycomb 21 structure, for example, or a rectangular, square or diamond-shaped cross-section. The core 20 comprises alveolar cells 21a. Each alveolar cell 21a, for example, has a hexagonal, triangular, square or diamond-shaped cross-section. The cross-section of the alveolar cells 21a may differ from one alveolar cell 21a to another. Each alveolar cell 21a is hollow and has an inner cavity 21b which communicates with at least one hole 18a. This allows each alveolar cell 21a to absorb some of the acoustic energy emitted by the turbine engine 1.

Advantageously, the core 20 comprises a radial superposition of alveolar cells 21a. The core 20 comprises, for example, a first lap of alveolar cells 21a and a second lap of alveolar cells (not shown). The first and second laps are separated by a septum. In the present technical field, a septum is a perforated membrane that is transparent to certain frequency ranges and impermeable to other frequency ranges. This configuration of the core 20 allows the outer shroud 14 to absorb sound energy over a wider frequency range. The first lap allows to absorb sound energy in a first frequency range, while the second lap allows to absorb sound energy in another frequency range.

The core 20 comprises, for example, a metallic material such as aluminum or a polymeric material chosen, for example, from thermoplastics or composites.

Advantageously, the core 20 is produced by additive manufacturing directly on the inner panel 18 or the outer panel 19. In this way, the manufacture of the outer shroud 14 according to the invention may be fully automated without a manual assembly step.

Alternatively, the core 20 is manufactured parallel to the inner panel 18 and then placed on the inner panel 18.

The core 20 is located at least in the upstream part 17 of the outer shroud 14.

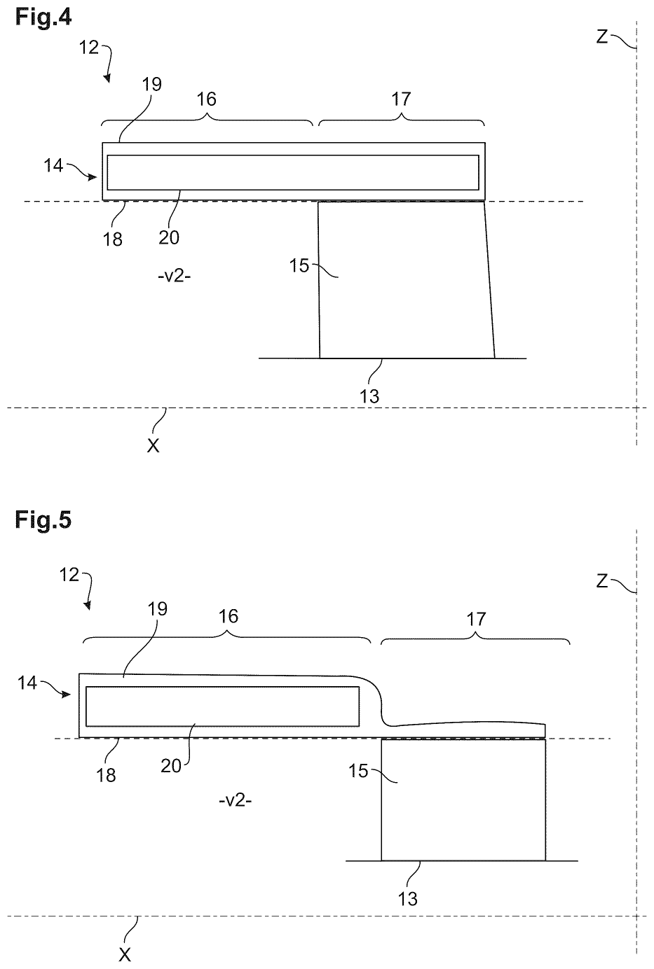

In a first preferred embodiment shown in FIG. 4, the core 20 is located in both the upstream part 16 and the downstream part 17 of the outer shroud 14.

According to a second embodiment shown in FIG. 5, the core 20 is located in the upstream part 16 and the downstream part 17 has no core 20.

The arms 15 are evenly spaced around the longitudinal axis X. They are connected to the inner and outer shrouds 13, 14 for example by inner and outer bolts 15a, 15b. The arms 15 may take the form of flow straightening vanes, referred by the acronym OGV for “Outlet Guided Vane”.

The outer shroud 14 according to the invention directly incorporates the acoustic insulation properties. Thanks to the invention, it is therefore possible to dispense with the need for acoustic panel sectors fitted and attached to the outer shroud. The acoustic properties of the outer shroud 14 are therefore greatly improved. The outer shroud 14 is lighter and less expensive.

Thanks to the invention, it is also possible to acoustically isolate the entire outer shroud 14, i.e. both the upstream and downstream parts 16, 17 of the outer shroud 14.

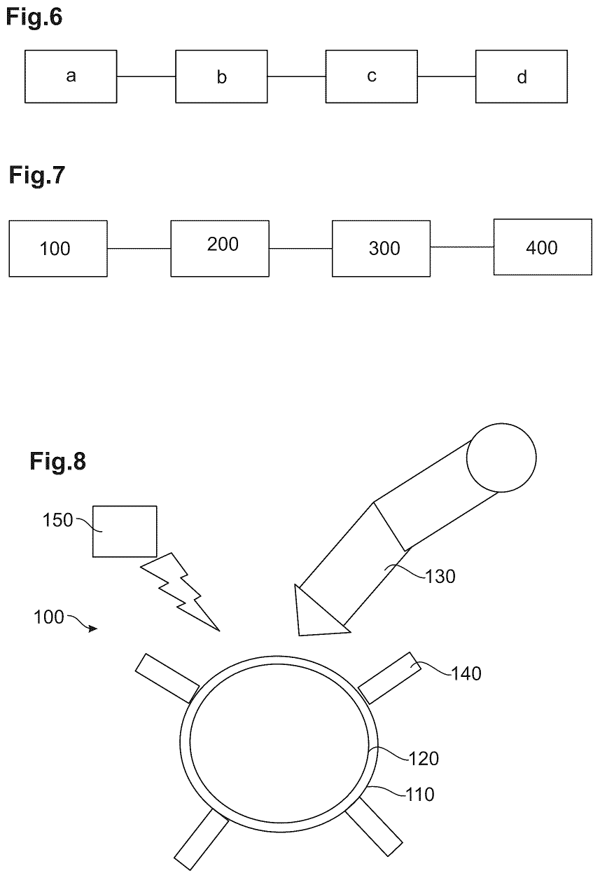

A method for manufacturing the intermediate casing 12 will now be described with reference to FIG. 6. The manufacturing method comprises the following steps:
(a) supplying the inner shroud 13,
(b) connecting the arms 15 to the inner shroud 13,
(c) supplying the outer shroud 14,
(d) connecting the outer shroud 14 to the arms 15.

According to the invention, step (c) comprises the following sub-steps performed in chronological order:
(c1) forming the inner panel 18,
(c2) placing the core 20 coaxially around the inner panel,
(c3) forming the outer panel 19 coaxially around the core 20,
(c4) optionally, treating thermally the inner and outer panels 18, 19, and
(c5) drilling the holes 18a in the inner panel 18.

Sub-steps (c1) and (c3) are advantageously carried out by an automatic fiber placement method, also referred to as AFP (Automated Fiber Placement).

In sub-steps (c1) and (c3), several strips 110 of pre-impregnated fibers are wound onto an annular support 120 using a robotic arm 140, for example. Advantageously, the strips 110 are then compacted and heated to encourage the strips 110 to adhere to each other. The heating temperature of the strips 110 is between 400 °C and 500 °C, preferably between 400 °C and 450 °C, even more preferably 420 °C when the matrix of the strips 110 is thermoplastic.

When the matrix of the strips 110 is of the thermosetting type, the heating temperature is between 20 °C and 120 °C.

In sub-step (c2), the core 20 is placed on the inner panel 18, preferably by additive manufacturing. This method offers the advantage of simplifying sub-step (c2) and allowing a greater variety of alveolar cell geometries 21a. This example is preferred when the matrix of the inner panel 18 is thermoplastic.

In another example, in sub-step (c2), the core is placed on the inner panel 18 manually.

In yet another example, in sub-step (c2), the core is placed on the inner panel 18 by a pick-and-place device.

Sub-step (c4) is particularly advantageous for polymerizing the thermosetting polymer matrix and thus consolidating the inner and outer panels 18, 19. Sub-step (c4) is a baking step. For example, it is carried out in an autoclave.

In sub-step (c5), the holes 18a are drilled using mechanical or laser drilling, for example.

The laser drilling, for example, is carried out using a laser. The laser is, for example, a short or ultra-short pulse power laser. Advantageously, the laser generates a radiation with a wavelength of between 1 nm and 1 mm. The radiation generated is therefore in the infrared, visible or ultraviolet range.

According to the invention, the manufacturing method for manufacturing the outer shroud 14 may be fully automated, which reduces the manufacturing time for the outer shroud 14 and considerably reduces manufacturing costs. Also, thanks to the implementation of the automatic fiber placement method, it is possible to produce the outer shroud 14 in the form of annular panels incorporating the acoustic insulation properties.

This allows to improve the acoustic properties of the outer shroud 14 and reduces the weight of the outer shroud 14.

An installation for manufacturing the outer shroud 14 will now be described with reference to FIG. 7.

The installation comprises a first station 100 for manufacturing the inner and outer panels 18, 19, a station 200 for placing the core 20, optionally a baking station 300 and a drilling station 400.

Referring to FIG. 8, the first station 100 comprises, for example, an unwinder 130 for the pre-impregnated fiber strips 110. The unwinder 130 allows to place the strips 110 on the support 120. The unwinder 130 is, for example, a robotic arm used to wind the strips 110 onto the annular support 120. The support 120 is, for example, a chuck.

The first station 100 also comprises a compacting roller 140. Advantageously, the first station 100 comprises a plurality of compacting rollers 140 evenly distributed around the support 120. The compacting roller 140 allows to apply a pressure to the strips 110 placed on the support 120 so as to encourage the adhesion between the strips 110.

The first station 100 also comprises a device for heating 150 the strips 110. The heating device 150 allows to heat the strips 110 as they are deposited on the support 120. This helps the strips 110 to adhere to each other by melting the matrix. The combination of pressure and temperature therefore encourages the strips 110 to adhere to each other.

The heating device 150 is, for example, a laser such as an infrared laser. The heating device 150 may rotate around the support 120, for example.

The placement station 200 comprises, for example, an additive manufacturing device or a “pick and place” placement device.

The additive manufacturing device comprises, for example, a first filament dispenser and a first extruder.

The baking station 300 comprises an autoclave, for example.

The drilling station 400 also comprises a member for drilling the inner panel 18. The drilling member is, for example, a laser or a mechanical drill. The laser is, for example, a short or ultra-short pulse power laser. Advantageously, the laser generates a radiation with a wavelength of between 1 nm and 1 mm. The radiation generated is therefore in the infrared, visible or ultraviolet range.

The installation according to the invention therefore allows the outer shroud 14 to be manufactured in-line.

1. A method for manufacturing an annular intermediate casing for an aircraft turbine engine, the intermediate casing having an axis of revolution and comprising:
an annular inner shroud centered on the axis of revolution
an annular outer shroud arranged coaxially around the inner shroud, and
radial arms connecting the inner and outer shrouds,
the outer shroud comprising:
an annular inner panel centered on the axis of revolution and extending around the arms, the inner panel comprising a first polymeric matrix and reinforcing fibers embedded in the first matrix
an annular outer panel arranged coaxially around the inner panel, the outer panel comprising a second polymeric matrix and reinforcing fibers embedded in the second matrix, and
an annular core arranged coaxially between the inner and outer panels wherein the method comprises a step (c) of producing the outer shroud, the step (c) comprising the following chronological sub-steps:
(c1) forming an annular inner panel centered on an axis of revolution by automatic fiber placement,
(c2) placing an annular core coaxially around the inner panel
(c3) forming an outer panel coaxially around the core by automatic fiber placement, and
(c4) treating thermally the inner and outer panels.

2. The method according to claim 1, wherein the method comprises, after sub-step (c4), a step (c5) of drilling the inner panel.

3. The method according to claim 2, wherein the drilling step (c5) is carried out by mechanical or laser drilling.

4. The method according to claim 1, wherein sub-steps (c1) and (c3) comprise the following steps:
winding strips of pre-impregnating fibers along the axis of revolution,
compacting and heating the strips to a first temperature below the thermal treatment temperature of step (c4).

5. The method according to claim 4, wherein the first temperature is between 20 °C and 500 C.

6. The method according to claim 1, wherein sub-step (c3) is carried out by additive manufacturing.

7. The method according to claim 1, wherein sub-step (c4) is carried out in an autoclave.

8. The method according to claim 1, wherein the core has a honeycomb structure.
